(19) United States
(12) Patent Application Publication
(10) Pub. No.: US 2002/0027328 A1
(43) Pub. Date: Mar. 7, 2002

(54) Sealing element for settlement joints

(76) Inventor: German Schindler, Mombris (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/846,921

(22) Filed: May 1, 2001

(30) Foreign Application Priority Data
May 2, 2000 (DE) 100 21 016.3

(51) Int. Cl. F16J 15/02

(52) U.S. Cl. 277/637

(57) ABSTRACT

The invention relates to a sealing element for a settlement joint between a building's floor surfaces provided with a floor covering, said sealing element comprising an elastic bridging profile that runs parallel to the settlement joint and that is made up of at least one sealing strip and of lateral longitudinal sealing strips that are connected to the L-shaped anchoring profile legs that delimit the settlement joint, said profiles having fastening legs that are essentially parallel to the floor surface and that are glued to the corresponding floor surface or to the leveling layer that is laid on top of it.

The invention refers to a sealing element for a settlement joint between a building's floor surfaces provided with a floor covering, said sealing element comprising an elastic bridging profile that runs parallel to the settlement joint and that is made up of at least one sealing strip and of lateral longitudinal sealing strips that are connected to the L-shaped anchoring profile legs that delimit the settlement joint, said profiles having fastening legs that are essentially parallel to the floor surface and that are connected to the corresponding floor surface either directly or with the insertion of a leveling layer.

There are numerous different settlement joints with sealing profiles.

A known variety, for example, is a waterproof settlement-joint sealing profile for a building's floor surfaces, consisting of an elastic bridging part that is held on each of its two longitudinal edges by an intermediate profile that is attached positively and non-positively to a leg of an anchoring bracket positioned perpendicular to the floor surface, whereby this anchoring bracket is connected to a leg situated essentially parallel to the floor surface on one of the parts of the building that are separated from each other by the settlement joint.

The anchoring bracket is anchored along the longitudinal extension of the settlement joint by means of screws distributed at intervals along the length. A layer of mortar arranged between the anchoring brackets and the floor surfaces serves to compensate for any irregularities in the carcass prior to the exact mounting of the anchoring brackets (German Preliminary Published Application No. 30 20 035 A1).

This settlement-joint sealing profile can certainly seal the settlement joint as such, but it entails the disadvantage that the lateral areas of the sealing profile, which are screwed tightly onto the adjacent floor areas, allow moisture to penetrate over the course of time. Moreover, the anchoring brackets are fastened by means of screws and this anchoring method is extremely complex. Screw holes have to be drilled along the building parts, in addition to which it must be ensured that the screws fit securely into the screw holes.

Over the course of time, this anchoring approach translates into a costly work method both in the case of new construction and when damaged joint seals have to be repaired.

In contrast, the invention is based on the objective of providing a remedy here and creating a sealing element for a settlement joint in such a way that not only the settlement joint but also the edge areas are completely sealed, a process which circumvents the need for screws in order to anchor the sealing element to the building parts along the joint.

It has been found that this objective can be achieved in a surprisingly simple manner by means of the features described in claims 1 and 2.

In the embodiment example according to claim 1, the fastening legs are glued directly onto the areas of the floor surfaces that run along the settlement joint. In this process, the adhesive compensates for any irregularities on the floor surfaces.

However, wherever there are considerable irregularities on the floor surfaces, in the embodiment example according to claim 2, a leveling layer is applied onto the floor surfaces prior to gluing the fastening legs, and the fastening legs are glued together with the leveling layer.

Which of the fastening methods is employed is decided as a function of the nature of the floor surfaces along the settlement joint.

Leveling layers according to the invention consist, for instance, of an epoxy resin base. Polyurethanes, epoxy resins as well as other materials are employed as the adhesives. The entire contact surfaces of the fastening legs are glued onto the leveling layer or onto the corresponding floor surface.

Improvements of the invention are described in the subordinate claims 3 through 28. In order to ensure secure adhesion of the glue onto the fastening legs, their bottom surfaces can have recesses running in the longitudinal direction.

According to claim 4, the recesses can also have dovetailed cross sections.

In a preferred embodiment, holes for the glue are provided in the fastening legs. This creates a sealing element which, according to claim 6, is characterized by a top adhesive layer on the top of the fastening legs that is connected by the glue in the holes to the adhesive of the bottom adhesive layer. As a result, according to claim 7, it is achieved that the fastening legs are sheathed by the top and bottom adhesive layers.

This ensures an extraordinarily secure sealing of the edge areas of the sealing element for the settlement joint.

The surfaces of the fastening legs can be provided with roughened areas that ensure secure bonding of the glue onto the fastening legs.

It is advantageous if a cover layer is provided between the top adhesive layer and the floor covering.

In another embodiment of the invention, fastening rails configured according to claim 12 are provided for purposes of pressing the lateral longitudinal strips of the bridging profile onto the receptacle of the L-shaped anchoring profile legs that delimit the settlement joint.

The legs of the fastening rail that run parallel to the floor surface are connected to the receptacles of the L-shaped anchoring profiles by means of screws which, according to claim 14, can be designed as tapping screws.

In order to simplify the tight screwing of the fastening rail, guide grooves are provided for the screws in the upper areas of the L-shaped anchoring profile legs that delimit the settlement joint.

In order to further facilitate the installation of the fastening rail, the lower edge of the leg of the fastening rail facing downwards rests on a support rim on the L-shaped anchoring profile legs that delimit the settlement joint.

Additional improvements can be gleaned from claims 17, 18 and 19. According to claim 19, the fastening rail can be installed in a particularly secure manner. The leg of the fastening rail facing downwards is inserted into the lengthwise groove that is delimited by an outer edge and is subsequently swiveled into its final position.

It is advantageous if journal webs are provided on the bottoms of the lateral longitudinal edges of the bridging profiles, whereby these webs engage into the corresponding channels in the L-shaped anchoring profile legs that are adjacent to the settlement joint.

The special configuration of these journal webs and of the corresponding channels is described in claims 21 through 25.

In order to adapt the sealing element according to the invention to varying heights of the floor covering, according to claim 26, an intermediate piece can be provided which is arranged between the top of the L-shaped anchoring profile leg that delimits the settlement joint and the leg of the fastening rail that is parallel to the floor surface. The height of this intermediate piece is adapted to the conditions in question.

The configuration of the intermediate piece is described in claim 27.

Another way to facilitate the installation of the sealing element according to the invention can be gleaned from claim 28.

Embodiments of the invention will be elaborated upon below with reference to the drawing.

The following is shown:

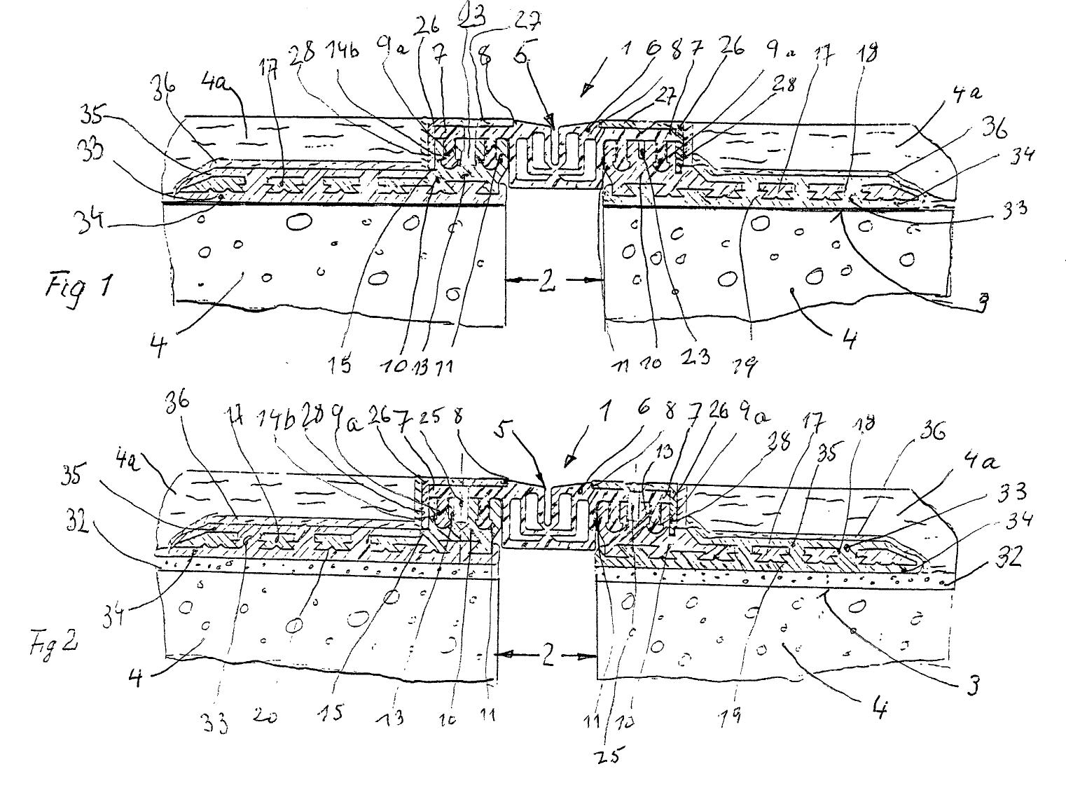

FIG. 1—a cross section through a sealing element without a leveling layer;

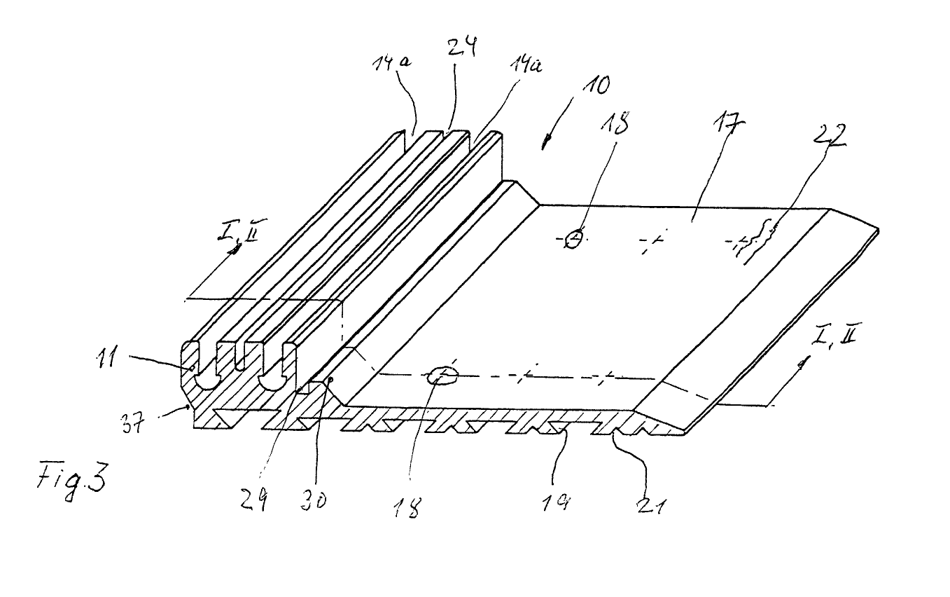

FIG. 2—a cross section through a sealing element having a leveling layer;

FIG. 3—a perspective view of an anchoring profile with a sectional line I-II or II-II along which the sections in FIGS. 1 and 2 have been made;

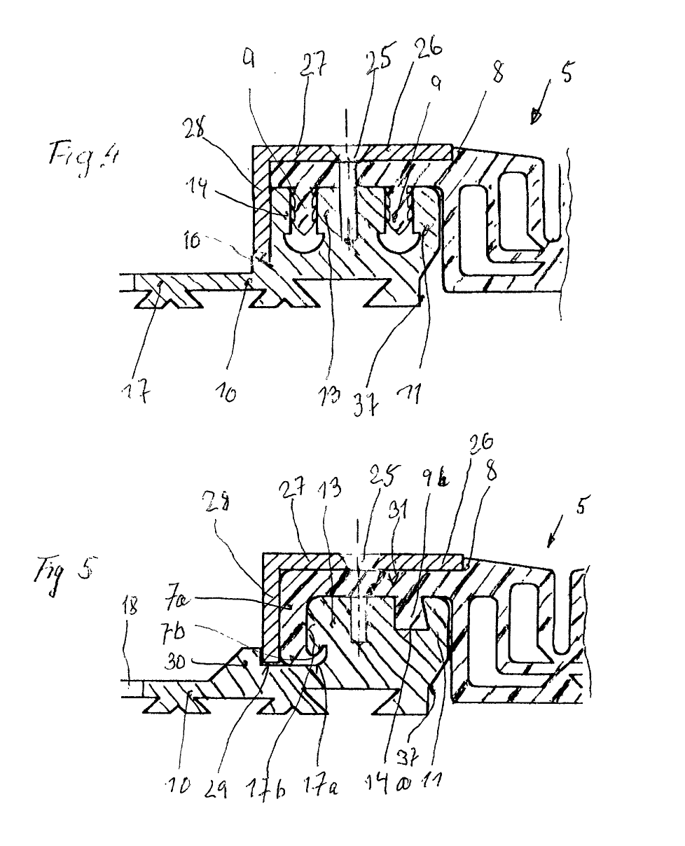

FIG. 4—a detailed sectional view of the L-shaped anchoring profile with the bridging profile;

FIG. 5—a cross section through the connection of a differently shaped bridging profile with the L-shaped anchoring profile;

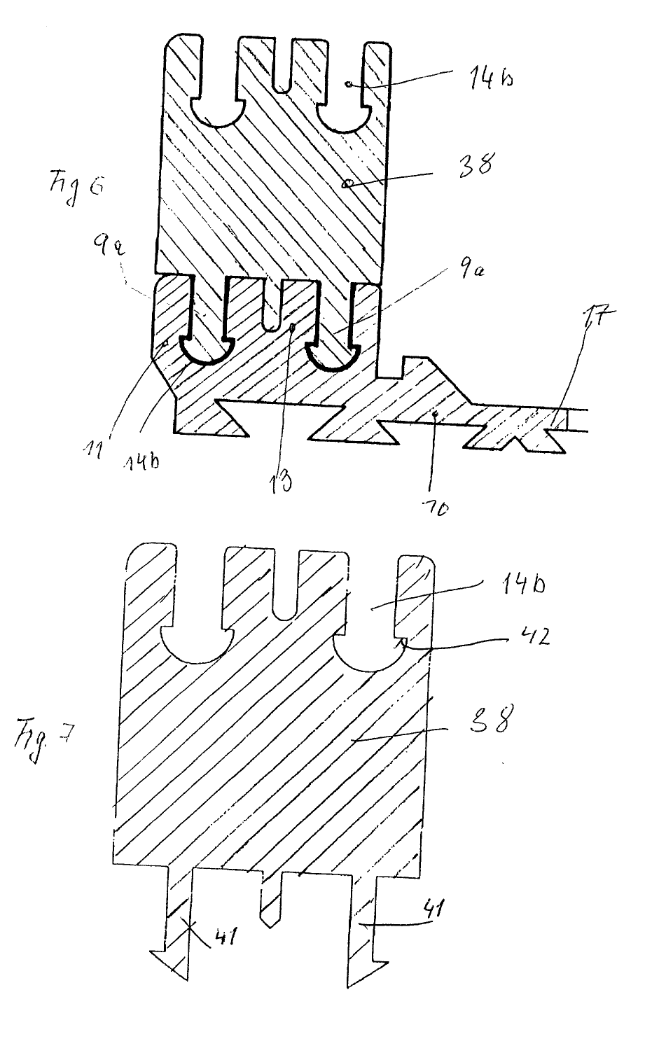

FIG. 6—an intermediate piece;

FIG. 7—another embodiment of an intermediate piece.

FIG. 1 shows a cross section of a sealing element generally designated with the reference numeral 1 for a settlement joint 2 between the floor surfaces 3 of a building 4 of which a left-hand half and a right-hand half are shown in a sectional view.

On the floor surfaces 3 of the building 4, there is a floor covering 4a whose sides facing the settlement joint 2 conform to parts of the sealing element 1.

The sealing element 1 consists of a bridging profile 5 that seals the joint 2 against moisture. In one embodiment, the bridging profile 5 consists of a sealing strip 6 which, without changing the essence of the invention, can have any desired, customary cross sections. In the embodiment shown, the sealing strip 6 consists of several strips whose ends located inside the settlement joint 2 are combined to form a nodal point. The sealing strip 6 is capable of absorbing movements that occur between the building parts 4 located to the right and left of the settlement joint.

The middle part of the sealing strip 6 is followed on the left-hand and right-hand sides by lateral longitudinal strips 7 that are connected to the L-shaped anchoring profile 10 legs 11 that delimit the settlement joint 2.

In order to secure this connection, journal webs 9 protrude from the bottoms of the lateral longitudinal strips 7 and these webs project into channels 14 in the receptacle 13 of the legs 11 that delimit the settlement joint 2.

As can be seen in FIGS. 1, 2 and 4 to 7, the journal webs 9 can be designed as non-removable journal webs 9a. In one embodiment, the non-removable journal webs are designed as dove-tailed journal webs 9b. According to FIG. 5, however, the lateral longitudinal strips 7 can have perpendicular shoulders 7a that end in the non-removable edge areas 7b. The channels in the receptacle 13, which receive the journal webs 9, 9a and 9b, have a matching cross section. In essence, the channel 14 according to FIG. 4 is configured with straight walls. However, it has an essentially semi-circular end with horizontal edges. The channel 14a according to FIG. 5 is configured so that the journal web 9b cannot be removed. According to FIGS. 1 and 2, the journal webs 9b can also completely occupy the receiving channels.

The journal webs 9 shown in FIG. 4 have barb-like shoulders along their circumference.

FIG. 7 depicts journal webs that are designed as barbs 41. They interact with the channels 14b (FIG. 6). The advantage of the journal webs 9 according to FIG. 4 and of the barbs 41 according to FIG. 7 lies in the fact that the lateral longitudinal strips 7 of the sealing strips 6 can simply be pressed in place from the top into their final installed position. The journal webs 9, 9a and 9b and the channels 14, 14a, 14b that receive them are designed as longitudinal webs or longitudinal grooves. They are arranged over the entire length of the lateral longitudinal strips 7 or of the receptacles 13.

In addition to the fastening by means of the journal webs 9 or by means of the barbs 41, fastening rails 26 are provided which are designed as angled rails having a leg 27 that runs parallel to the floor surfaces 3 and a leg 28 that points downwards. As can be seen in the figures, these fastening rails 26 are screwed on by means of screws to the L-shaped anchoring profile 10 legs 11 that delimit the settlement joint 2. For this purpose, screw holes 23 can be provided in the receptacles 13. The screws can be designed as tapping screws. However, longitudinal grooves 29 can also be provided in the receptacles 13 and the screws 25, which are tapping screws, can be screwed into these grooves 29. The longitudinal grooves 29 are dimensioned in such a way as to ensure that the screws 25 fit securely.

In order to allow a secure installation of the fastening rail 26, the downwards-pointing leg 28 of the fastening rails 12 can be provided with a support rim 15. In another embodiment, the lower edge of the downward-pointing leg 28 of the fastening rail 26 is arranged in a longitudinal groove 29 that is delimited by an outer edge 30 (FIG. 5). When the fastening rail 26 is installed, the lower edge of the downward-pointing leg 28 is first inserted into the longitudinal groove 29. Subsequently, the fastening rail is swiveled to the right as shown in FIG. 5, whereby the lower end of the downward-pointing leg 28 meets resistance at the outer edge 30. The fastening rail 26 can be swiveled into the installation position depicted in FIG. 5 in which it is easy to insert the screws 25. In this process, the perpendicular shoulder 7a is firmly pressed at the lateral longitudinal edge 7 of the sealing strip 6 onto the outer wall of the receptacle 13 while the non-removable edge area 7b is also pressed into the longitudinal groove 17a. As a result, owing to the interaction of the downward-pointing leg 28 with the perpendicular shoulder 7a of the lateral longitudinal strips 7, firm contact is established which prevents the sealing strip 6 from shifting vis-a-vis the L-shaped anchoring profile 10. The fit of the shoulder 7a and of the non-removable edge area 7b is facilitated by the longitudinal channel 17a or 17b.

FIG. 1 shows that the fastening leg 17 of the L-shaped anchoring profiles 10 is glued by means of a bottom adhesive layer 34 comprising a glue generally designated by the reference numeral 33 onto the floor surface 3 of the building parts 4. The bottom adhesive layer is applied onto the surface 3 in such a thickness that the glue 33 penetrates through holes 18 into the fastening leg 17 as the latter is lowered, thus forming a top adhesive layer 35 above the fastening leg 17. FIGS. 1 and 2 illustrate the arrangement of the glue 33 in the adhesive layers 34 and 35. Accordingly, the fastening legs 17 are covered by the glue 33.

In the embodiment according to FIG. 1, the surface 3 of the building parts 4 is so smooth that the glue 33 can be applied directly onto the floor surface 3. The glue compensates for minor irregularities.

According to FIG. 2, a leveling layer 32 is applied onto an uneven floor surface 3, onto which the fastening leg 17 is glued.

Above the top adhesive layers 35, covering layers 36 are provided which, together with the adhesive layers, ensure a tight seal with respect to the floor surfaces 3 of the building 4.

FIGS. 1 and 2 also show a floor covering 4a that is laid up to the fastening rail 26. Between the downward-pointing leg 28 of the fastening rail and the floor covering 4a, there is a joint filler made, for example, on the basis of silicone.

Especially in FIGS. 4 and 5, indentations 37 can be seen into which a part of the leg 11 that delimits the settlement joint 2 can deflect, for example, if the sealing element moves due to heat.

FIG. 3 shows a perspective view of the fastening leg 17 of the L-shaped anchoring profile 10. It can be clearly seen that, at the bottom part of the fastening leg 17, dovetailed recesses 19 or recesses 21 are provided into which glue 33 penetrates (FIGS. 1 and 2) in order to ensure a secure fit for the fastening leg 17 on the surface 3.

FIG. 6 shows a cross section of an intermediate piece 38 that can be arranged between the receptacle 31 of the L-shaped anchoring profile 10 and the lateral longitudinal strips 7 of the sealing strip 6 when the floor covering 4a (FIGS. 1, 2—not shown in FIG. 6) exceeds a certain height. The channels 14b arranged in the receptacle 13 are also arranged in the upper area of the intermediate piece 38. The non-removable journal webs 9a on the bottom of the lateral longitudinal strips 7 of the sealing strip 6 can be inserted into these channels. In a corresponding manner, journal webs 9a are present on the bottom of the intermediate piece 38 and these engage into the channels 14b in the receptacle 13.

The upper area of the intermediate piece 38 according to FIG. 7 has channels 14b having stop rims 42 while its bottom area has barbs 41 that can be inserted into the channels 14b with stop rims 42 in the receptacle 13.

List of the Reference Numerals Employed

1 sealing element

2 settlement joint

3 floor surface

4a floor covering

5 bridging profile

6 sealing strip

7 lateral longitudinal strip

7a vertical shoulder

7b non-removable edge area

8 depression

9 journal web

9a non-removable journal web

9b dovetailed journal web

10 L-shaped anchoring profile

11 the leg that delimits the settlement joint (2)

12

13 receptacle

14 channel

14a channel

14b channel

15 support rim

16 chamfering

17 fastening leg

17a longitudinal channel

17b longitudinal channel

18 hole

19 dovetailed recess

20 recess

21 recess

22 roughened area

23 screw hole

24 guide groove

25 screw

26 fastening rail

27 parallel leg

28 downward-pointing leg

29 longitudinal groove

30 outer edge

31 longitudinal groove

32 leveling layer

33 glue

34 bottom adhesive layer

35 top adhesive layer

36 covering layer

37 indentation

38 intermediate piece

39 journal web

40

41 barb

42 stop rim

1. A sealing element (1) for a settlement joint (2) between a building's (4) floor surfaces (3) provided with a floor covering (4a), said sealing element comprising an elastic bridging profile (5) that runs parallel to the settlement joint (2) and that is made up of at least one sealing strip (6) and of lateral longitudinal strips (7) that are connected to the L-shaped anchoring profile (10) legs (11) that delimit the settlement joint, said profiles having fastening legs (17) that are essentially parallel to the floor surface (3) and that are connected to the corresponding floor surface (3),
characterized in that
between the fastening legs (17) and the floor surfaces (3), an adhesive layer (34) is provided by means of which the fastening legs (17) of the anchoring profiles (10) are fastened to the floor surfaces (3).

2. A sealing element (1) for a settlement joint (2) between a building's (4) floor surfaces (3) provided with a floor covering (4a), said sealing element comprising an elastic bridging profile (5) that runs parallel to the settlement joint (2) and that is made up of at least one sealing strip (6) and of lateral longitudinal strips (7) that are connected to the L-shaped anchoring profile (10) legs (11) that delimit the settlement joint, said profiles having fastening legs (17) that are essentially parallel to the floor surface (3) and that are connected to the corresponding floor surface (3) with the insertion of a leveling layer (32),
characterized in that
between the fastening legs (17) and the leveling layers (32), an adhesive layer (34) is provided by means of which the fastening legs (17) of the anchoring profiles (10) are fastened to the leveling layers (32).

3. The sealing element according to claim 1 or 2,
characterized in that
recesses (19, 20, 21) running in the longitudinal direction are provided in the bottom surface of the fastening legs (17).

4. The sealing element according to claim 3,
characterized in that
the recesses (19) have dovetailed cross sections.

5. The sealing element according to one of the preceding claims,
characterized in that
holes (18) for glue (33) are provided in the fastening legs (17).

6. The sealing element according to one of the preceding claims,
characterized by a top adhesive layer (35) on the top of the fastening leg that connects the glue (33) in the holes (18) with the glue (33) of the bottom adhesive layer (34).

7. The sealing element according to claim 6,
characterized in that
the fastening legs (17) are sheathed by the top and bottom adhesive layers (35, 34).

8. The sealing element according to one of the preceding claims,
characterized in that
the surfaces of the fastening legs (17) are provided with roughened areas (22).

9. The sealing element according to one of the preceding claims,
characterized in that
the bottom adhesive layer (34) completely fills the recesses (19, 20, 21).

10. The sealing element according to one of the preceding claims,
characterized in that
a covering layer (36) is provided between the top adhesive layer (35) and the floor covering (4a).

11. The sealing element according to one of the preceding claims,
characterized in that
a fastening rail (26) is provided for purposes of pressing the lateral longitudinal strips (7) of the bridging profile (5) onto the receptacles (13) of the L-shaped anchoring profile (10) legs (11) that delimit the settlement joint (2).

12. The sealing element according to claim 1
characterized in that
the fastening rail is configured as an angled rail (26) having a leg (27) that runs parallel to the floor surface (3) as well as a downward-pointing leg (28).

13. The sealing element according to claims 11 and 12,
characterized in that
the leg (27)—running parallel to the floor surface (3)—of the fastening rail (26) is connected by means of screws (25) to the receptacle (13) of the L-shaped anchoring profile (10).

14. The sealing element according to claim 13,
characterized in that
the screws are tapping screws (25).

15. The sealing element according to claim 13 or 14,
characterized in that,
guide grooves (24) are provided for the screws (25) in the upper areas of the L-shaped anchoring profile (10) legs (11) that delimit the settlement joint (2).

16. The sealing element according to one of claims 11 through 13,
characterized in that
the bottom edge of the downward-pointing leg (28) of the fastening rail (26) stands on a support rim (15) on the L-shaped anchoring profile (10) legs (11) that delimit the settlement joint (2).

17. The sealing element according to claims 16,
characterized in that
the bottom edge of the downward-pointing leg (28) of the fastening rail (26) and the support rim (15) are chamfered.

18. The sealing element according to one of claims 16 to 17,
characterized in that
the bottom edge of the downward-pointing leg (28) of the fastening rail (26) is arranged in a longitudinal groove (29) in the L-shaped anchoring profile (10).

19. The sealing element according to claim 18,
characterized in that
the longitudinal groove ((29) is delimited by an outer edge (30).

20. Sealing element according to one of the preceding claims,
characterized in that
journal webs (9, 9a, 9b) are provided on the bottoms of the lateral longitudinal strips (7) of the bridging profiles (5) and said journal webs engage into corresponding channels (14, 14a, 14b) in the L-shaped anchoring profile (10) legs (11) that are adjacent to the settlement joint (2).

21. The sealing element according to claim 20,
characterized in that the journal webs (9a) and the corresponding channels (14a) are configured so as to be non-removable.

22. The sealing element according to claim 20,
characterized in that
the non-removable journal webs (9a) and the corresponding channels (14a) have circular or semi-circular cross sections.

23. The sealing element according to claim 21,
characterized in that the non-removable journal webs (9b) and the corresponding channels (14b) are configured so as to be dove-tailed.

24. The sealing element according to claim 21,
characterized in that
the journal webs are configured as barbs (41) and the channels have corresponding stop rims (42).

25. The sealing element according to one of the preceding claims,
characterized in that
the lateral longitudinal strips (7) of the bridging profile (5) make the transition into shoulders (7a) having non-removable edge areas (7b) which fit into longitudinal channels (17a, 17b) of the L-shaped anchoring profile (10) legs (11) that delimit the settlement joint (2).

26. The sealing element according to one of the preceding claims,
characterized by
an intermediate piece (38) between the top of the L-shaped anchoring profile (10) legs (11) that delimit the settlement joint (2) and the leg (27) of the fastening rail (26) that runs parallel to the floor surface (3).

27. The sealing element according to claim 26,
characterized in that
journal webs (9, 39) or channels (17b, 38a) are provided on the intermediate piece (38) on the bottom of the parallel leg (27) of the fastening rail (26) and on the top of the L-shaped anchoring profile (10) legs (11) that delimit the settlement joint (2).

28. The sealing element according to one of the preceding claims,
characterized in that
an indentation (37) is provided on the bottom boundary surface of the fastening leg (17) to the settlement joint (2) in order to receive the lower area of the bridging part (5) when under load.
